(19) United States
(12) Patent Application Publication
(10) Pub. No.: US 2007/0084838 A1
(43) Pub. Date: Apr. 19, 2007

(54) METHOD AND CUTTING SYSTEM FOR CUTTING A WAFER BY LASER USING A VACUUM WORKING TABLE

(76) Inventor: Chih-Ming Hsu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/538,818

(22) Filed: Oct. 5, 2006

Related U.S. Application Data
(63) Continuation-in-part of application No. 11/007,336, filed on Dec. 7, 2004, now abandoned.

(51) Int. Cl. B23K 26/38; B23K 26/03

(52) U.S. Cl. 219/121.72; 219/121.83; 219/121.67; 219/121.82

(57) ABSTRACT

A laser cutting system for cutting a wafer includes a working table capable of holding a wafer with a vacuum device. The wafer is monitored on a first side by an electronic micro camera for positioning the wafer to a cutting location. A laser device mounted above the working table generates a laser beam for cutting a second side of the wafer when the electronic micro camera is monitoring and guiding the wafer carried by the working table along an accurate route.

### CROSS REFERENCE TO RELATED APPLICATIONS

This is a continuation-in-part of application Ser. No. 11/007,336, filed Dec. 7, 2004, and which is included in its entirety herein by reference.

### BACKGROUND OF THE INVENTION

1. Field of the Invention

The present invention relates to a laser cutting method and cutting system, in particularly, a laser cutting method and system using a vacuum working table.

2. Description of the Prior Art

In current procedures for manufacturing light-emitting diodes (LED) and memory chips, numerous densely arrayed crystallite units are produced on a chip, and a laser cutting apparatus is used to cut the crystalline units into numerous crystallites.

A typical chip includes an electrode layer, a gem layer, and an epilayer (or epitaxy layer) between the electrode layer and the gem layer. In a laser cutting procedure, the chip is placed on a working table of a laser cutting apparatus, with the electrode layer facing upward and downward. An electronic micro camera is mounted above the working table for observing the electrode layer or the gem layer, showing the arrangement and location of each crystallite unit in the epilayer of the chip and allowing the operator to adjust the position of the working table and the chip. The chip is cut by a laser beam from top to obtain individual crystallites.

The electrode layer and the gem layer of the chip are light-transmissible layers, which is suitable to observation and laser cutting from top. However, a metal layer not transmissible to light is added on an outer face of the gem layer for a chip for high-performance, high-brightness LEDs, or high-frequency memories, forming a light-tight layer. Thus, the chip must be placed on the working table with the electrode layer facing upward to allow observation by the electronic micro camera from top, with the laser beam cutting the light transmissible electrode layer, the epilayer, and the light-tight layer (including the metal layer and the gem layer) from top. However, the energy intensity required for cutting is too strong and thus causes damage to the chip performance, resulting in a poor ratio of qualified crystallites as well as a low production rate.

### SUMMARY OF THE INVENTION

The claimed invention provides a method for cutting a wafer by laser using a vacuum working table. The method comprises adhering a film to a first side of a wafer; generating a vacuum state between the film adhered to the first side of the wafer and the vacuum working table for fixing the wafer to the vacuum working table; observing the first side of the wafer with an electronic micro camera for positioning the wafer; moving the wafer to a cutting location; and cutting a second side of the wafer with a cutting device.

The claimed invention also provides a cutting system using a vacuum working table. The cutting system comprises a working table capable of holding a wafer; a vacuum generator connected to a vacuum outlet of a holding plate of the working table for drawing out air from a room of a supporting pedestal of the working table; a laser device mounted above the working table for generating a laser beam for cutting a second side of the wafer; and a first electronic micro camera mounted below the working table for monitoring the first side of the wafer, allowing for the working table to position in accordance with the laser device. The working table comprises the supporting pedestal having the room and the vacuum outlet for air in the room being drawn out; the holding plate having a plurality of through holes supported by the supporting pedestal for holding the first side of the wafer, the plurality of through holes are connecting between the room of the supporting pedestal and the first side of the wafer; and a three-way moving platform having a through-hole mounted below the supporting pedestal for moving and rotating the supporting pedestal.

The claimed invention also provides a working table capable of holding a wafer with a vacuum device. The working table comprises a supporting pedestal having a room and a vacuum outlet for air in the room being drawn out; a holding plate having a plurality of through holes supported by the supporting pedestal for holding a first side of the wafer, the plurality of through holes are connecting between the room of the supporting pedestal and the first side of the wafer; and a three-way moving platform having a through-hole mounted below the supporting pedestal for moving and rotating the supporting pedestal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of the method for cutting a wafer by laser using a vacuum working table according to the present invention.

FIG. 2 is an illustration of a cutting system using a vacuum working table according to the present invention.

FIG. 3 is an illustration of a wafer.

FIG. 4 is an illustration of the working table.

### DETAILED DESCRIPTION

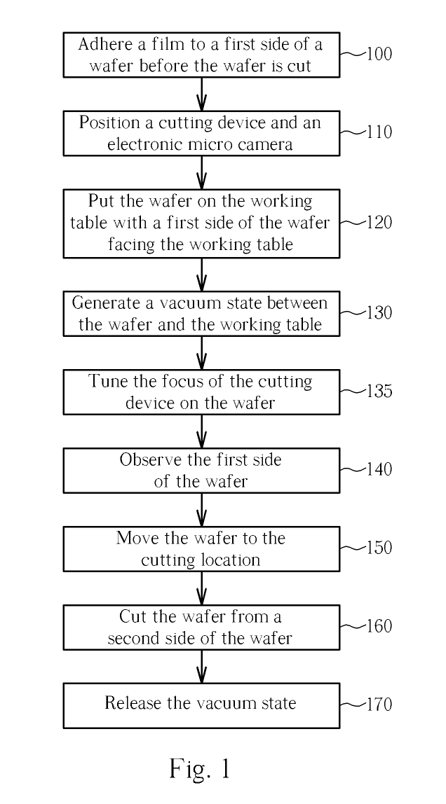

Please refer to FIG. 1. FIG. 1 is an illustration of the method for cutting a wafer by laser using a vacuum working table according to the present invention. The cutting method comprises the following steps.

Step 100: adhere a film to a first side of a wafer before the wafer is cut;

Step 110: mutually position the cutting center of a cutting device and the monitoring center of an electronic micro camera;

Step 120: put the wafer on the working table with the first side of the wafer with the film, which is light transmissible, facing the working table;

Step 130: generate a vacuum state between the film adhered to the first side of the wafer and the working table;

Step 135: use a second electronic micro camera mounted on the same side as the cutting device for tuning the focus of the cutting device on the wafer;

Step 140: observe the first side of the wafer with the electronic micro camera since the first side of the wafer contains the epitaxy layer;

Step 150: through the observation of the electronic micro camera on the wafer, move the wafer to the cutting location;

Step 160: use the cutting device to cut the wafer from a second side of the wafer;

Step 170: when cutting finishes, release the vacuum state between the film adhered to the first side of the wafer and the working table to remove to wafer from the working table.

Before the wafer is ready to be cut, a transparent film is first adhered to the first side of the wafer, as in Step 100. The arrangement of each layer of the wafer from the first side to the second side is the electrode layer, the epitaxy layer, the gem layer, and finally the metal layer. In other word, the electrode layer and the epitaxy layer lie in the first side of the wafer having the arrangement and location of each crystallite unit for being observed and individually obtained. The gem layer and the metal layer lie in the second side of the wafer. All layers (including the electrode layer and the epitaxy layer) but the metal layer is light transmissible. The first side of the wafer is facing the electronic micro camera rather than directly facing the cutting device, usually a laser device, so that the epitaxy layer won't be damaged by direct laser beam as in Step 120. Therefore, the method of the present invention adheres the transparent film onto the first side of the wafer, providing a smooth surface that can be completely fixed to the working table once the vacuum state between the first side of the wafer and the working table is established. Generally, the electronic micro camera is mounted under the working table, and the cutting device is mounted above the working table and therefore, the wafer lies on the working table with its first side facing downward and second side, which is light-tight, facing upward and toward the cutting device.

The cutting system also ensures that the cutting device and the electronic micro camera are axially in line with each other by adjusting the position of the cutting device or the position of the electronic micro camera (together with the working table) before the wafer is mounted on the working table. The axis where the laser beam transmitted from the cutting device represents the cutting center and generally there is a cross on the lens of the electronic micro camera that provides a monitoring center of the electronic micro camera. At the stage of step 110, the locations of the cutting center and the monitoring center substantially coincide. Usually Step 110 can be achieved either by moving the electronic micro camera (along with the whole working table) or by moving the cutting device. Fine calibration of the two axes is done in Step 140.

After the wafer is put on the working table correctly as in Step 120, a vacuum generator mounted in the working table generates the vacuum state that can tightly fix the wafer to the working table as in Step 130. The electronic micro camera mounted under the working table monitors upward the first side of the wafer and the cutting device mounted above the working table cuts downward the wafer from the second side. A second electronic micro camera mounted above the wafer, which is on the same side as the cutting device is, is used for proceeding focus tuning of the cutting device as in Step 135.

In Step 140, the electronic micro camera monitors not only the cutting location at the first side of the wafer but the laser beam generated by the cutting device. To protect the lens of the electronic micro camera from being damaged by the laser beam, a laser filtering lens is further applied on the lens of the electronic micro camera for filtering laser beam transmitted to the electronic micro camera. Before practically cutting through the wafer, the cutting device must first cut through the second side of the wafer, the light-tight metal layer. Once the metal layer is cut through, the laser beam from the cutting device is observable to the electronic micro camera. Through observing from the first side of the wafer, the electronic micro camera spots the cutting-through point caused by the cutting device from the second side of the wafer. The fine calibration of the coaxial alignment between the cutting device and the electronic micro camera takes place when the electronic micro camera spots the cutting through point for more precise positioning between the cutting device and the electronic micro camera.

The operator can control the movement of the working table so that the wafer can be moved to the exact location and the cutting device and cut the wafer into individual crystallites as in Step 150 and Step 160. During the cutting process as in Step 160, the operator uses the electronic micro camera below the working table to monitor the cutting process and guild the working table and the wafer so that the laser beam from the cutting device can cut the wafer under control. Finally, the wafer can be removed after the cutting is finished and the vacuum state between the wafer and the working table is released.

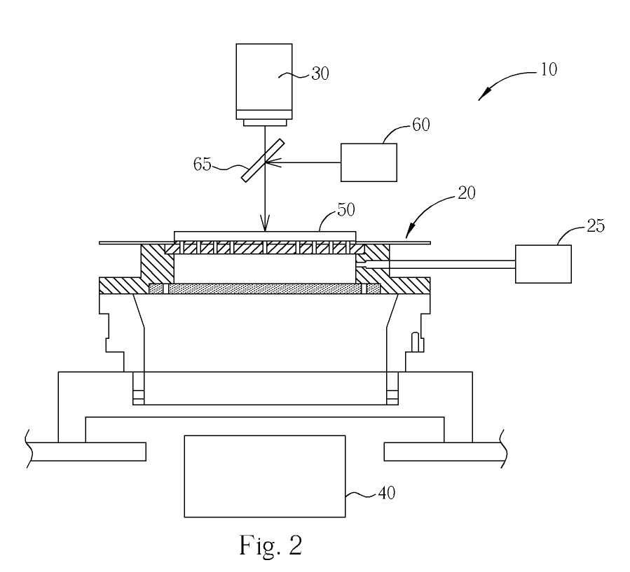

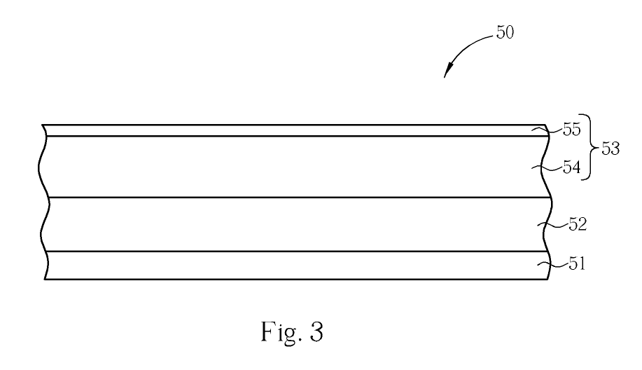

In order to accomplish the cutting method disclosed in the specification, the cutting system 10, as shown in FIG. 2, comprises a working table 20 capable of holding a wafer 50, a vacuum generator 25 for generating vacuum state in the working table 20, a laser device 30 mounted above the working table 20, a first electronic micro camera 40 mounted below the working table 20 for monitoring an epitaxy layer of the wafer 50 and the cutting process, and a second electronic micro camera 60 mounted above the working table 20 for tuning the focus of the laser device 30. Generally, the first and second electronic micro cameras 20,40 are charge-coupled devices (CCDs) or other image monitoring devices. The wafer 50 is mounted on the working table 20 with the light transmissible layer (or electrode layer) 51 facing toward the working table 20 (or facing downward in FIG. 2), the epitaxy layer 52 above the light transmissible layer 51, the light tight layer 53 above the epitaxy layer 52. The light tight layer 53 includes a gem layer 54 and a metal layer 55 above the gem layer 54. The illustration of the wafer 50 is shown in FIG. 3.

As the cutting method of the present invention previously discloses, the electronic micro camera 40 is mounted below the working table 20 in order to monitor the epitaxy layer 52 of the wafer 50 since the light transmissible layers of the wafer 50 are facing downward. The laser device 30 mounted above the working table 20 (also above the wafer 50) generates laser beam downward and cuts the light tight layer 53 from the upper side of the wafer 50. Before the laser device 30 is cutting the wafer 50, the focus of the laser device 30 on the wafer 50 is tuned by the second electronic micro camera 60 through observing lights reflected by a reflecting lens 65 from the surface of the wafer 50. A laser filtering lens (not shown in the figure) is also installed on the first electronic micro camera 40 so that the laser beam transmitted by the laser device 30 does not damage the lens of the first electronic micro camera 40.

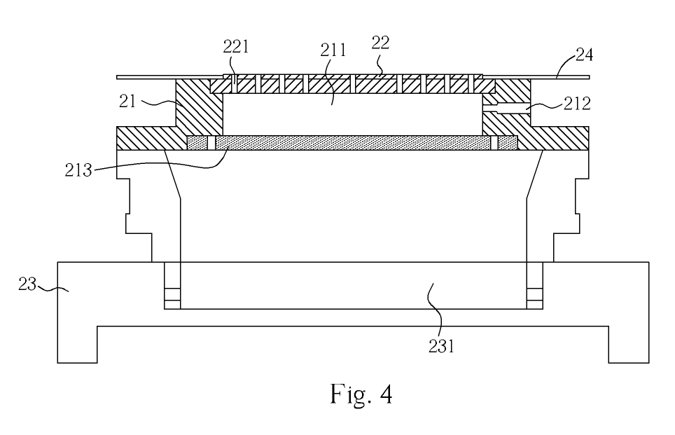

To hold the wafer 50 and allow the first electronic micro camera 40 to monitor the downside of the wafer 50, the cutting system 10 of the present invention generates vacuum state between the wafer 50 and the working table 20 by the vacuum generator 25. Meanwhile, the working table 20 of the cutting system 10 is as shown in FIG. 4, comprising a supporting pedestal 21, a holding plate 22 supported by the supporting pedestal 21 for directly holding the wafer 50, and a three-way moving platform 23 mounted below the supporting pedestal 21 as a base of the working table 20 for moving and rotating the supporting pedestal 21 and the holding plate 22 horizontally. The supporting pedestal 21 comprises a room 211 and a vacuum outlet 212 for air in the room 211 being drawn out. The vacuum generator 25 connects to the vacuum outlet 212 and draws out air from the room 211. For more effective vacuum state generation, an extra partition plate 213, generally a transparent acrylic plate can be settled in the supporting pedestal 21 to make the room 211 isolated. The holding plate 22 is a light transmissible quartz plate and has a plurality of through holes 221 that connect between the room 211 of the supporting pedestal 21 and the upper surface of the holding plate 22, which directly contacts the downside, i.e., the light transmissible layer of the wafer 50. The working table 20 also comprises a fixing ring 24 installed around the holding plate 22 for fixing the holding plate 22 on the supporting pedestal 21. With the plurality of through holes 221, when the vacuum generator 25 draws air in the room 211 through the vacuum outlet 212, the light transmissible layer (with a film adhered on it in advance) is tightly fixed on the upper surface of the holding plate 22. Since the holding plate 22 is made of light transmissible quartz plate, the partition plate 213 is transparent, and the three-way moving platform 23 mentioned above comprises a through-hole 231, the downside of the wafer 50 is observable from the bottom of the working table 20 by the first electronic micro camera 40 and the wafer 50 can be monitored for being cut into individual crystallites by the laser device 30.

The present invention discloses a laser cutting system for cutting the wafer includes the working table capable of holding the wafer with the vacuum device. The wafer is monitored on the first side by the first electronic micro camera for positioning the wafer to a cutting location. The laser device mounted above the working table generates a laser beam for cutting the second side of the wafer when the first electronic micro camera is monitoring and guiding the wafer carried by the working table along an accurate route.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for cutting a wafer by laser using a vacuum working table, comprising:
adhering a film to a first side of a wafer;
generating a vacuum state between the film adhered to the first side of the wafer and the vacuum working table for fixing the wafer to the vacuum working table;
observing the first side of the wafer with an electronic micro camera for positioning the wafer;
moving the wafer to a cutting location; and
cutting a second side of the wafer with a cutting device.

2. The method of claim 1 further comprising releasing the vacuum state between the film adhered to the first side of the wafer and the vacuum working table after finishing cutting the second side of the wafer with the cutting device.

3. The method of claim 1 further comprising using a second electronic micro camera for tuning the focus of the cutting device.

4. The method of claim 1 further comprising mutually positioning the cutting center of the cutting device and the monitoring center of the electronic micro camera.

5. The method of claim 1 wherein observing the first side of the wafer with an electronic micro camera for positioning the wafer comprises observing a cutting-through point through the first side of the wafer generated by the cutting device.

6. The method of claim 5 wherein observing the first side of the wafer with an electronic micro camera for positioning the wafer comprises using a laser filtering lens for filtering laser beam transmitted to the electronic micro camera.

7. The method of claim 1 wherein moving the wafer to a cutting location comprises finely calibrating the position of the wafer to the cutting location.

8. The method of claim 1 wherein cutting a second side of the wafer with a cutting device comprises monitoring the first side of the wafer with the electronic micro camera when cutting the second side of the wafer.

9. The method of claim 1 wherein cutting a second side of the wafer with a cutting device comprises using a laser device for cutting the second side of the wafer.

10. A cutting system using a vacuum working table, comprising:
a working table capable of holding a wafer, comprising:
a supporting pedestal having a room and a vacuum outlet for air in the room being drawn out;
a holding plate having a plurality of through holes supported by the supporting pedestal for holding a first side of the wafer, the plurality of through holes are connecting between the room of the supporting pedestal and the first side of the wafer; and
a three-way moving platform having a through-hole mounted below the supporting pedestal for moving and rotating the supporting pedestal;
a vacuum generator connected to the vacuum outlet for drawing out air from the room of the supporting pedestal;
a laser device mounted above the working table for generating a laser beam for cutting a second side of the wafer; and
a first electronic micro camera mounted below the working table for monitoring the first side of the wafer, allowing for the working table to position in accordance with the laser device.

11. The cutting system of claim 10 wherein the working table further comprises a fixing ring installed around the holding plate for fixing the holding plate on the supporting pedestal.

12. The cutting system of claim 10 wherein the holding plate is a light-transmissible quartz plate.

13. The cutting system of claim 10 further comprising a second electronic micro camera mounted above the working table for tuning the focus of the laser device.

14. The cutting system of claim 13 wherein the second electronic micro camera is a charge-coupled device (CCD).

15. The cutting system of claim 10 wherein the first electronic micro camera is a charge-coupled device (CCD).

16. The cutting system of claim 10 wherein the first electronic micro camera comprises a laser filtering lens.

17. A working table capable of holding a wafer with a vacuum device, comprising:
a supporting pedestal having a room and a vacuum outlet for air in the room being drawn out;
a holding plate having a plurality of through holes supported by the supporting pedestal for holding a first side of the wafer, the plurality of through holes are connecting between the room of the supporting pedestal and the first side of the wafer; and
a three-way moving platform having a through-hole mounted below the supporting pedestal for moving and rotating the supporting pedestal.

18. The working table of claim 17 further comprising a fixing ring installed around the holding plate for fixing the holding plate on the supporting pedestal.

19. The working table of claim 17 wherein the holding plate is a light-transmissible quartz plate.
